(19) United States
(12) Patent Application Publication
(10) Pub. No.: US 2026/0062977 A1
(43) Pub. Date: Mar. 5, 2026

(54) METHOD, IN-VEHICLE APPARATUS, AND NON-TRANSITORY COMPUTER READABLE MEDIUM

(71) Applicant: TOYOTA JIDOSHA KABUSHIKI KAISHA, Toyota-shi (JP)

(72) Inventors: Mitsuhiro MIURA, Toyota-shi (JP); Yoshiaki TOMATSU, Toyoake-shi (JP)

(73) Assignee: TOYOTA JIDOSHA KABUSHIKI KAISHA, Toyota-shi (JP)

(21) Appl. No.: 19/256,699

(22) Filed: Jul. 1, 2025

(30) Foreign Application Priority Data
Aug. 30, 2024 (JP) 2024-149897

(51) Int. Cl. E05F 15/40; B60Q 3/44; B60Q 3/47; G06V 20/59; G06V 40/10

(52) U.S. Cl. CPC E05F 15/40; B60Q 3/44; B60Q 3/47; G06V 20/59; G06V 40/10; B60Q 2800/30; E05Y 2900/506; E05Y 2900/531

(57) ABSTRACT

A method performed by an in-vehicle apparatus includes setting, in video captured by an imager, a first area and a second area in front of a door in an interior of a vehicle, extracting one or more passengers and one or more objects from the video using an image analysis technique, and causing an opening and closing operation of the door to stop, upon detecting, in the video, a passenger present in the first area and/or an object present in the second area.

### CROSS-REFERENCE TO RELATED APPLICATION

This application claims priority to Japanese Patent Application No. 2024-149897 filed on Aug. 30, 2024, the entire contents of which are incorporated herein by reference.

### TECHNICAL FIELD

The present disclosure relates to a method, an in-vehicle apparatus, and a program.

### BACKGROUND

There is technology for detecting objects in the vicinity of doors of vehicles. For example, Patent Literature (PTL) 1 discloses that a door pinch detection area and a gap detection area are provided in the vicinity of a door of a railroad vehicle.

### CITATION LIST

### Patent Literature

PTL 1: JP 2022-134452 A

### SUMMARY

In the vicinity of a door, persons and objects behave differently, and thus need to be detected separately. In addition, whenever light passed through window glass of the door of a vehicle is erroneously detected as an object, an opening and closing operation of the door is stopped, which causes annoyance. Thus, there is room for improvement with respect to technology for detecting objects in the vicinity of doors of vehicles.

A method according to the present disclosure is a method performed by an in-vehicle apparatus including an imager configured to image an interior of a vehicle, and a controller, the method including:
setting, by the controller, in video captured by the imager, a first area and a second area in front of a door in the interior of the vehicle;
extracting, by the controller, one or more passengers and one or more objects from the video using an image analysis technique; and
causing, by the controller, an opening and closing operation of the door to stop, upon detecting, in the video, a passenger present in the first area and/or an object present in the second area.

An in-vehicle apparatus according to the present disclosure includes:
an imager configured to image an interior of a vehicle; and
a controller configured to:
   set, in video captured by the imager, a first area and a second area in front of a door in the interior of the vehicle;
   extract one or more passengers and one or more objects from the video using an image analysis technique; and
   cause an opening and closing operation of the door to stop, upon detecting, in the video, a passenger present in the first area and/or an object present in the second area.

A program according to the present disclosure is configured to cause a computer, as an in-vehicle apparatus including an imager configured to image an interior of a vehicle, and a controller, to execute operations, the operations including:
setting, in video captured by the imager, a first area and a second area in front of a door in the interior of the vehicle;
extracting one or more passengers and one or more objects from the video using an image analysis technique; and
causing an opening and closing operation of the door to stop, upon detecting, in the video, a passenger present in the first area and/or an object present in the second area.

According to the present disclosure, it is possible to improve technology for detecting objects in the vicinity of doors of vehicles.

### BRIEF DESCRIPTION OF THE DRAWINGS

In the accompanying drawings:

FIG. 1 is a diagram illustrating a schematic configuration of an in-vehicle apparatus according to embodiments of the present disclosure;

FIG. 2 is a flowchart illustrating an example of operations of an in-vehicle apparatus according to a first embodiment;

FIG. 3 is a diagram illustrating video acquired by the in-vehicle apparatus;

FIG. 4 is a flowchart illustrating an example of operations of an in-vehicle apparatus according to a second embodiment;

FIG. 5A is a diagram illustrating video acquired by the in-vehicle apparatus; and

FIG. 5B is a diagram illustrating the video acquired by the in-vehicle apparatus.

### DETAILED DESCRIPTION

### First Embodiment

A first embodiment of the present disclosure will be described below, with reference to the drawings. In the drawings, the same or corresponding portions are denoted by the same reference numerals. In the descriptions of the present embodiment, detailed descriptions of the same or corresponding portions are omitted or simplified as appropriate.

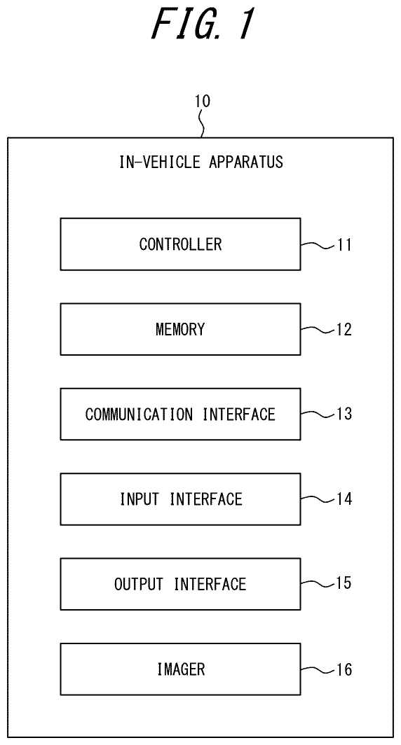

An outline of an in-vehicle apparatus 10 according to the present embodiment will be described with reference to FIG. 1. The in-vehicle apparatus 10 is a computer installed in a vehicle.

The vehicle includes, for example, a route bus, a tourist bus, or the like. The vehicle is, for example, any type of automobile such as a gasoline vehicle, a diesel vehicle, a hydrogen vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The vehicle may be driven by a driver, or the driving may be automated at any level. The automation level is, for example, any one of Level 1 to Level 5 according to the level classification defined by SAE. The name “SAE” is an abbreviation of Society of Automotive Engineers. The vehicle may be a MaaS-dedicated vehicle. The term “MaaS” is an abbreviation of Mobility as a Service. The vehicle is provided with a controller that controls operations of various parts of the vehicle, including a door.

First, an outline of the present embodiment will be described, and details thereof will be described later. The in-vehicle apparatus 10 sets, in video of an interior of the vehicle, a first area and a second area in front of the door in the interior of the vehicle. The in-vehicle apparatus 10 extracts one or more passengers and one or more objects from the video using an image analysis technique. The in-vehicle apparatus 10 causes an opening and closing operation of the door to stop, upon detecting, in the video using the image analysis technique, a passenger present in the first area and/or an object present in the second area.

The objects include baggage, strollers, carrying cases, or the like carried by the passengers. According to the present embodiment, a passenger and an object are detected separately in the first and second areas. As described below, detecting an object in the second area, which is smaller in size than the first area to detect a passenger, reduces the possibility of erroneous detection of something other than objects, such as light shining through a window, as an object. Thus, it is possible to safely cause the opening and closing operation to stop only when a passenger or an object is actually present in the vicinity of the door, while eliminating inconvenience due to frequent stopping of the opening and closing operation of the door or frequent notifications indicating that an object has been detected. Therefore, it is possible to improve technology for detecting objects in the vicinity of doors of vehicles.

A configuration of the in-vehicle apparatus 10 according to the present embodiment will be described with reference to FIG. 1. The in-vehicle apparatus 10 includes a controller 11, a memory 12, a communication interface 13, an input interface 14, an output interface 15, and an imager 16. These components are communicably connected to each other, for example, via an in-vehicle network, such as a Controller Area Network (CAN), or a dedicated line.

The controller 11 includes at least one processor, at least one dedicated circuit, or a combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The dedicated circuit is, for example, an FPGA or an ASIC. The term “FPGA” is an abbreviation of field-programmable gate array. The term “ASIC” is an abbreviation of application specific integrated circuit. The controller 11 may include an ECU. The term “ECU” is an abbreviation of Electronic Control Unit. The controller 11 executes processes related to operations of the in-vehicle apparatus 10 while controlling components of the in-vehicle apparatus 10.

The memory 12 includes at least one semiconductor memory, at least one magnetic memory, at least one optical memory, or a combination of at least two of these. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 12 functions as, for example, a main memory, an auxiliary memory, or a cache memory. The memory 12 stores information to be used for the operations of the in-vehicle apparatus 10 and information obtained by the operations of the in-vehicle apparatus 10. The information stored in the memory 12 may be updated with information acquired from a network via the communication interface 13.

The communication interface 13 includes at least one interface for communication. The interface for communication is, for example, an interface compliant with a mobile communication standard such as LTE, the 4G standard, or the 5G standard, an interface compliant with a short-range wireless communication standard such as Bluetooth® (Bluetooth is a registered trademark in Japan, other countries, or both), or a LAN interface. The term “LTE” is an abbreviation of Long Term Evolution. The term “4G” is an abbreviation of 4th generation. The term “5G” is an abbreviation of 5th generation. The communication interface 13 receives information to be used for the operations of the in-vehicle apparatus 10 via the network, and transmits information obtained by the operations of the in-vehicle apparatus 10 via the network.

The network includes the Internet, at least one WAN, at least one MAN, or any combination thereof. The term “WAN” is an abbreviation of wide area network. The term “MAN” is an abbreviation of metropolitan area network. The network may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

The input interface 14 includes at least one interface for input. The interface for input is, for example, a physical key, a capacitive key, a pointing device, a touch screen integrally provided with a display, or a microphone. The input interface 14 accepts operations for inputting data to be used for operations of the vehicle and the in-vehicle apparatus 10. The input interface 14, instead of being included in the in-vehicle apparatus 10, may be connected to the in-vehicle apparatus 10 as an external input device. As a connection method, for example, any technology such as USB, HDMI® (HDMI is a registered trademark in Japan, other countries, or both), or Bluetooth® can be used. The term “USB” is an abbreviation of Universal Serial Bus. The term “HDMI®” is an abbreviation of High-Definition Multimedia Interface.

The output interface 15 includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The output interface 15 outputs data obtained by the operations of the vehicle and the in-vehicle apparatus 10. The output interface 15, instead of being included in the in-vehicle apparatus 10, may be connected to the in-vehicle apparatus 10 as an external output device. As a connection method, for example, any technology such as USB, HDMI®, or Bluetooth® can be used.

The imager 16 is a camera that images the interior of the vehicle. The imager 16 outputs captured video to the controller 11. The imager 16 is installed on a ceiling of the vehicle, for example, and can capture the video of the door of the vehicle and a floor in front of the door.

The functions of the in-vehicle apparatus 10 are realized by execution of a program according to the present embodiment by a processor serving as the controller 11. That is, the functions of the in-vehicle apparatus 10 are realized by software. The program causes a computer to execute the operations of the in-vehicle apparatus 10, thereby causing the computer to function as the in-vehicle apparatus 10. That is, the computer executes the operations of the in-vehicle apparatus 10 in accordance with the program to thereby function as the in-vehicle apparatus 10.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, the program stored in the portable medium or the program transferred from the server. Then, the computer reads the program stored in the main memory using the processor, and executes processes in accordance with the read program using the processor. The computer may read the program directly from the portable medium, and execute processes in accordance with the program. The computer may, each time a program is transferred from the server to the computer, sequentially execute processes in accordance with the received program. Instead of transferring the program from the server to the computer, processes may be executed by a so-called ASP type service that realizes functions only by execution instructions and result acquisitions. The term “ASP” is an abbreviation of application service provider. The program encompasses information that is to be used for processing by an electronic computer and is thus equivalent to a program. For example, data that is not a direct command to a computer but has a property that regulates processing of the computer is “equivalent to a program” in this context.

Some or all of the functions of the in-vehicle apparatus 10 may be realized by a programmable circuit or a dedicated circuit serving as the controller 11. That is, some or all of the functions of the in-vehicle apparatus 10 may be realized by hardware.

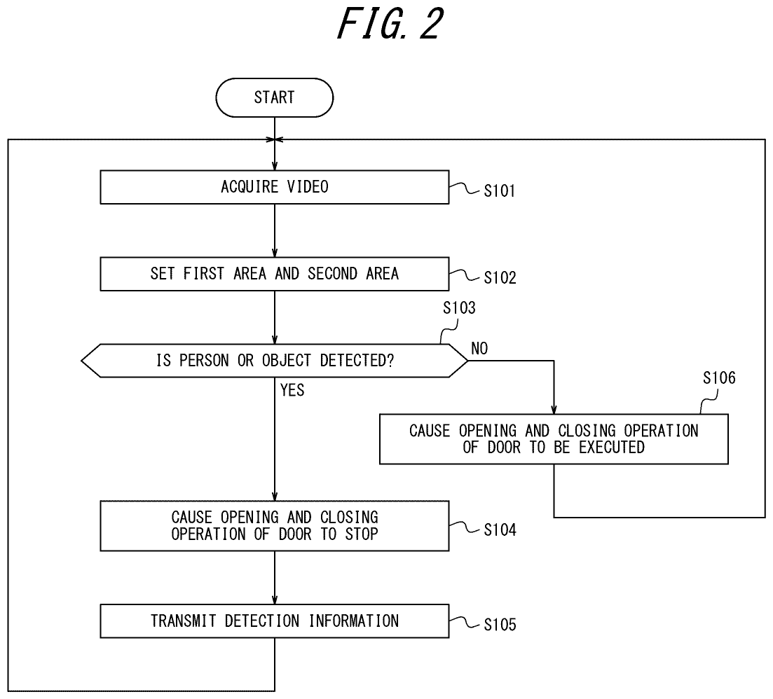

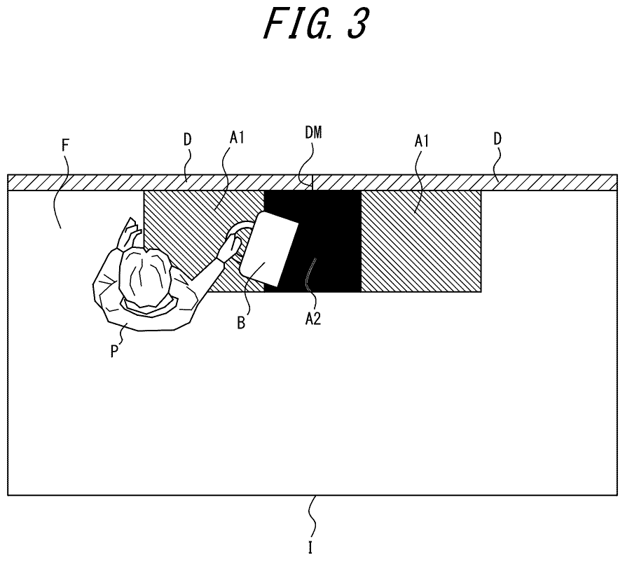

Operations of the in-vehicle apparatus 10 according to the present embodiment will be described with reference to FIGS. 2 and 3. The operations in FIG. 2 correspond to a method according to the present embodiment. In the following, communication between the in-vehicle apparatus 10 and an external apparatus is carried out via the communication interface 13 and the network.

In S101 of FIG. 2, the controller 11 of the in-vehicle apparatus 10 acquires video from the imager 16. The controller 11 may acquire the video at the timing of executing an opening and closing operation of the door of the vehicle. For example, upon acquiring, from a controller of the vehicle, information indicating that the vehicle stops for passengers getting on or off, or departs, the controller 11 may acquire, from the imager 16, the video captured by the imager 16. The controller 11 may acquire information indicating the acceleration of the vehicle, which is detected by an acceleration sensor of the vehicle, and acquire, from the imager 16, the video captured by the imager 16 when the acceleration of the vehicle is equal to or more than a predetermined value. FIG. 3 illustrates video I captured by the imager 16. The video I captures a floor F of the interior of the vehicle, a door D, a passenger P standing in front of the door D, and baggage B carried by the passenger P.

In S102, the controller 11 sets, in the video acquired in S101, a first area and a second area in front of the door in the interior of the vehicle. The first and second areas are two-dimensional plane regions that partition the floor of the vehicle in the video, and are regions within a predetermined distance from the position of a mating point when the door is closed. For example, the controller 11 extracts the door and the position of the mating point of the door in the acquired video using any image analysis technique, and sets, as the first and second areas, rectangular regions one side of which coincides with the door of the vehicle, containing the mating point of the door. The first and second areas are not limited to being rectangular, but may be in any shape, such as circular. The controller 11 may set a first area A1 and a second area A2 such that the first area A1 overlaps at least part of the second area A2. The set first area A1 may contain the set second area A2. In FIG. 3, the first area A1 and the second area A2, which the controller 11 has set in the video I, are diagonally shaded and blackened, respectively. With reference to FIG. 3, the first area A1 and the second area A2 overlap, and the second area A2 is smaller in size than the first area A1. Both the first area A1 and the second area A2 are rectangular regions one side of which coincides with the door D, containing a mating point DM of the door D, and are rectangular regions within a predetermined distance from the mating point DM when the door D is closed.

In S103 of FIG. 2, the controller 11 determines whether a passenger present in the first area and/or an object present in the second area are/is detected from the video acquired in S101. The controller 11 first extracts, from the video using any image analysis technique, regions indicating one or more passengers and/or one or more objects. The controller 11, for example, extracts, in the acquired video, the regions indicating the one or more passengers and/or the one or more objects, based on the amounts of characteristics of contours represented by pixels of different colors from the floor. The regions indicating the passengers or the objects may be rectangular, circular, or in the shape of the contours enclosed with curved lines. The controller 11 determines that the presence of a passenger is detected when at least part of the region of the passenger or the entirety of the region of the passenger overlaps the first area set in S102. The controller 11 determines that the presence of an object is detected when at least part of the region of the object or the entirety of the region of the object overlaps the second area set in S102. When the passenger and/or the object are/is detected, the processing of the controller 11 proceeds to S104. When neither passenger nor object is detected, the processing of the controller 11 proceeds to S106.

In S104, the controller 11 generates a control signal to cause the opening and closing operation of the door to stop, and outputs the control signal to the controller of the vehicle. When the vehicle is provided with multiple doors, the control signal may include door identification information indicating a door that is captured in the video and that is a target of the stopping of the opening and closing operation. The controller of the vehicle acquires the control signal, and stops the opening and closing operation of the door based on the control signal. When the control signal includes the door identification information, the controller of the vehicle stops, based on the door identification information, the opening and closing operation of the target door. The operation of the controller 11 of the in-vehicle apparatus 10 then proceeds to S105.

In S105, the controller 11 transmits, via the communication interface 13 to a terminal apparatus of a user who monitors the vehicle, detection information indicating that the passenger present in the first area and/or the object present in the second area have/has been detected. The user who monitors the vehicle includes a crew member of the vehicle, an administrator who controls or monitors the vehicle remotely, or the like. By receiving the detection information by the terminal apparatus, the user can immediately know that the passenger or the object has been detected in the vicinity of the door of the vehicle. For example, when the user as a crew member is monitoring a monitor as the output interface 15, the controller 11 may output the detection information to the output interface 15. The user may transmit information indicating, for example, a warning to the in-vehicle apparatus 10. In this case, the controller 11 of the in-vehicle apparatus 10 may receive the information, and output a message such as “Please stand away from the door” or “Please place the object away from the door” audibly or by an image through the output interface 15.

In S106, the controller 11 outputs, to the controller of the vehicle, a control signal to cause the opening and closing operation of the door to be executed. When the vehicle is provided with multiple doors, the control signal may include door identification information indicating a door that is captured in the video and that is a target of executing the opening and closing operation. The controller of the vehicle executes the opening and closing operation of the door based on the control signal. When the control signal includes the door identification information, the controller of the vehicle executes, based on the door identification information, the opening and closing operation of the target door. The operation of the controller 11 of the in-vehicle apparatus 10 then returns to S101.

### Second Embodiment

Next, a second embodiment of the present disclosure will be described. A configuration of an in-vehicle apparatus 10 according to the second embodiment is the same as that according to the above first embodiment, so a description thereof is omitted.

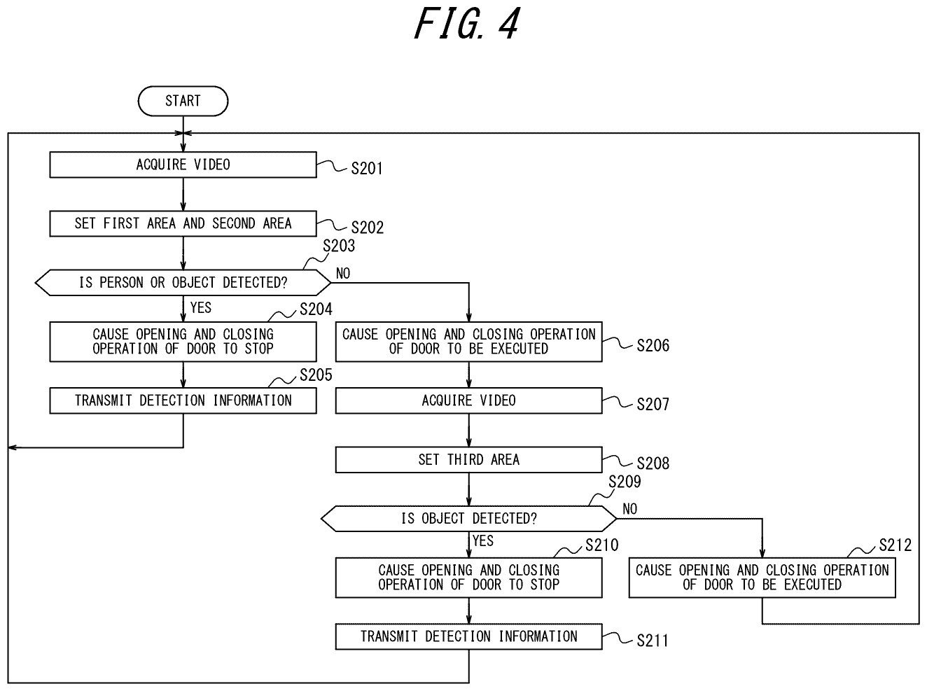

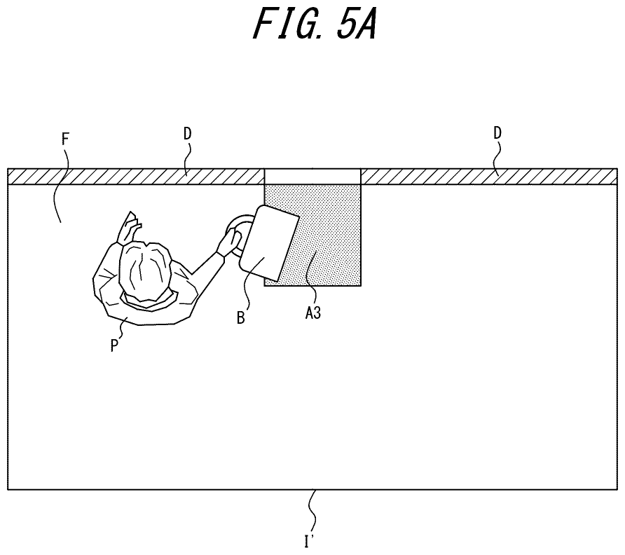

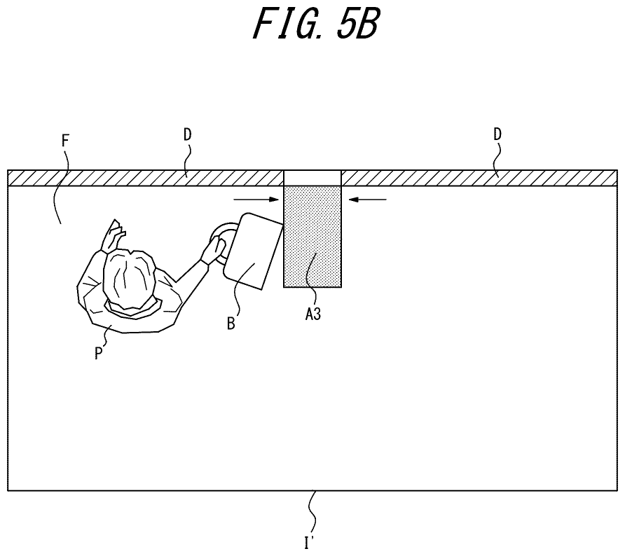

Operations of the in-vehicle apparatus 10 according to the present embodiment will be described with reference to FIGS. 4 to 5B.

S201 to S206 of FIG. 4 are the same as S101 to S106 of FIG. 2 according to the above first embodiment, so descriptions thereof are omitted.

In S207, the controller 11 acquires video from the imager 16. The controller 11 may acquire the video from the imager 16, at the same time as the controller 11 outputs, to the controller of the vehicle, the control signal to cause the opening and closing operation of the door to be executed in S206.

In S208, the controller 11 sets, in the video acquired in S207, a third area in front of the door in the interior of the vehicle. The third area is, just as with the first and second areas, a two-dimensional plane region that partitions the floor of the vehicle in the video, and is a region within a predetermined distance from the position of the mating point when the door is closed. In the present embodiment, the controller 11 extracts the door and the position of the mating point of the door in the acquired video using any image analysis technique, and sets, as the third area, a rectangular region one side of which coincides with the door of the vehicle, containing the mating point of the door. The third area is not limited to being rectangular, but may be in any shape, such as circular. Not limited to this, the controller 11 may set, as the third area, an area that has the same size as the second area, or that is equal to or smaller in size than the second area.

The controller 11 may detect the opening and closing operation of the door of the vehicle from the video acquired in S207 using any image analysis technique, and set the third area whose shape varies according to the opening and closing operation. In other words, the third area may vary in size, according to the degree of opening of the door of the vehicle during the opening and closing operation. FIGS. 5A and 5B illustrate, with dot hatching, a third area A3 set by the controller 11 in video I′ acquired in S207. FIG. 5A illustrates the door D open, and FIG. 5 illustrates the door D closing in the direction of the arrow. As illustrated in FIGS. 5A and 5B, the third area A3 becomes smaller in size as the door D closes. The third area A3 may also become larger in size as the door D opens.

In S209 of FIG. 4, the controller 11 determines whether an object present in the third area is detected from the video acquired in S207. The controller 11 first extracts, from the video using any image analysis technique, regions indicating one or more objects. The controller 11, for example, extracts, in the acquired video, the regions indicating the one or more objects, based on the amounts of characteristics of contours represented by pixels of different colors from the floor. The regions indicating the objects may be rectangular, circular, or in the shape of the contours enclosed with curved lines. The controller 11 determines that the presence of an object is detected when at least part of the region of the object or the entirety of the region of the object overlaps the third area. When the object is detected, the processing of the controller 11 proceeds to S210. When no object is detected, the processing of the controller 11 proceeds to S212.

S210 to S212 are the same as S104 to S106 of FIG. 2 according to the above first embodiment, so descriptions thereof are omitted.

According to the present embodiment, only the object in front of the door can be detected separately from passengers, after the door of the vehicle re-starts the opening and closing operation. This makes it easier to detect the object, for example, when a passenger has unintendedly left baggage in front of the door while the passenger himself/herself has stood away from the door, which allows safe stopping of the opening and closing operation of the door.

### (Variation)

As a variation of the present disclosure, the in-vehicle apparatus 10 may further be provided with a projector that projects an image onto the floor of the vehicle. The projector includes, for example, a projector that is installed on the ceiling of the vehicle and can project an image onto the floor of the interior of the vehicle. In this variation, when setting the first to third areas in S102 of FIG. 2 above or S202 or S208 of FIG. 4 above, the controller 11 transmits, to the projector, instructions to project an image representing the set areas onto the floor of the actual vehicle. The image includes, for example, an image representing the set areas highlighted in colors or lines. Image data representing the first to third areas may be stored in advance in the memory 12. Since the projector that has received such instructions projects the image onto the floor, passengers in front of the door can easily recognize the areas from which the passengers should keep their bodies or baggage away.

The present disclosure is not limited to the embodiment described above. For example, two or more blocks described in the block diagram may be integrated, or a block may be divided. Instead of executing two or more steps described in the flowchart in chronological order in accordance with the description, the steps may be executed in parallel or in a different order according to the processing capability of the apparatus that executes each step, or as required. Other modifications can be made without departing from the spirit of the present disclosure.

Examples of some embodiments of the present disclosure are described below. However, it should be noted that the embodiments of the present disclosure are not limited to these examples.
[Appendix 1] A method performed by an in-vehicle apparatus comprising an imager configured to image an interior of a vehicle, and a controller, the method comprising:
   setting, by the controller, in video captured by the imager, a first area and a second area in front of a door in the interior of the vehicle;
   extracting, by the controller, one or more passengers and one or more objects from the video using an image analysis technique; and
   causing, by the controller, an opening and closing operation of the door to stop, upon detecting, in the video, a passenger present in the first area and/or an object present in the second area.
[Appendix 2] The method according to appendix 1, wherein the second area is smaller in size than the first area.
[Appendix 3] The method according to appendix 1, wherein
   the in-vehicle apparatus further comprises a communication interface configured to communicate with a terminal apparatus of a user who monitors the vehicle, and
   the method further comprises transmitting, by the controller to the terminal apparatus via the communication interface, detection information indicating detection of the passenger present in the first area and/or the object present in the second area.
[Appendix 4] The method according to appendix 1, further comprising causing, by the controller, the opening and closing operation of the door to stop again, upon detecting, during the opening and closing operation of the door, an object present in the second area.
[Appendix 5] The method according to any one of appendices 1 to 4, wherein the first area contains the second area.
[Appendix 6] The method according to any one of appendices 1 to 4, wherein
   the in-vehicle apparatus further comprises a projector configured to project an image onto a floor of the vehicle, and
   the method further comprises projecting, by the controller via the projector onto the floor, an image indicating the first area and/or the second area.
[Appendix 7] The method according to any one of appendices 1 to 4, further comprising:
   further setting, by the controller, in the video, a third area whose size varies according to a degree of opening of the door during the opening and closing operation; and
   causing, by the controller, the opening and closing operation of the door to stop again, upon detecting, in the video using the image analysis technique, an object present in the third area.
[Appendix 8] The method according to appendix 7, wherein the third area becomes smaller in size as the degree of opening of the door decreases.
[Appendix 9] An in-vehicle apparatus comprising:
   an imager configured to image an interior of a vehicle; and
   a controller configured to:
      set, in video captured by the imager, a first area and a second area in front of a door in the interior of the vehicle;
      extract one or more passengers and one or more objects from the video using an image analysis technique; and
      cause an opening and closing operation of the door to stop, upon detecting, in the video, a passenger present in the first area and/or an object present in the second area.
[Appendix 10] The in-vehicle apparatus according to appendix 9, wherein the second area is smaller in size than the first area.
[Appendix 11] The in-vehicle apparatus according to appendix 9, further comprising a communication interface configured to communicate with a terminal apparatus of a user who monitors the vehicle,
   wherein the controller is configured to transmit, to the terminal apparatus via the communication interface, detection information indicating detection of the passenger present in the first area and/or the object present in the second area.
[Appendix 12] The in-vehicle apparatus according to appendix 9, wherein the controller is configured to cause the opening and closing operation of the door to stop again, upon detecting, during the opening and closing operation of the door, an object present in the second area.
[Appendix 13] The in-vehicle apparatus according to any one of appendices 9 to 12, wherein the first area contains the second area.
[Appendix 14] The in-vehicle apparatus according to any one of appendices 9 to 12, further comprising a projector configured to project an image onto a floor of the vehicle,
   wherein the controller is configured to project, via the projector onto the floor, an image indicating the first area and/or the second area.
[Appendix 15] The in-vehicle apparatus according to any one of appendices 9 to 12, wherein the controller is configured to:
   further set, in the video, a third area whose size varies according to a degree of opening of the door during the opening and closing operation; and
   cause the opening and closing operation of the door to stop again, upon detecting, in the video using the image analysis technique, an object present in the third area.
[Appendix 16] The in-vehicle apparatus according to appendix 15, wherein the third area becomes smaller in size as the degree of opening of the door decreases.
[Appendix 17] A program configured to cause a computer, as an in-vehicle apparatus comprising an imager configured to image an interior of a vehicle, and a controller, to execute operations, the operations comprising:
   setting, in video captured by the imager, a first area and a second area in front of a door in the interior of the vehicle;
   extracting one or more passengers and one or more objects from the video using an image analysis technique; and
   causing an opening and closing operation of the door to stop, upon detecting, in the video, a passenger present in the first area and/or an object present in the second area.
[Appendix 18] The program according to appendix 17, wherein the second area is smaller in size than the first area.
[Appendix 19] The program according to appendix 17, wherein
   the in-vehicle apparatus further comprises a communication interface configured to communicate with a terminal apparatus of a user who monitors the vehicle, and
   the operations further comprise transmitting, to the terminal apparatus via the communication interface, detection information indicating detection of the passenger present in the first area and/or the object present in the second area.
[Appendix 20] The program according to appendix 17, wherein the operations further comprise causing the opening and closing operation of the door to stop again, upon detecting, during the opening and closing operation of the door, an object present in the second area.

1. A method performed by an in-vehicle apparatus comprising an imager configured to image an interior of a vehicle, and a controller, the method comprising:
setting, by the controller, in video captured by the imager, a first area and a second area in front of a door in the interior of the vehicle;
extracting, by the controller, one or more passengers and one or more objects from the video using an image analysis technique; and
causing, by the controller, an opening and closing operation of the door to stop, upon detecting, in the video, a passenger present in the first area and/or an object present in the second area.

2. The method according to claim 1, wherein the second area is smaller in size than the first area.

3. The method according to claim 1, wherein
the in-vehicle apparatus further comprises a communication interface configured to communicate with a terminal apparatus of a user who monitors the vehicle, and
the method further comprises transmitting, by the controller to the terminal apparatus via the communication interface, detection information indicating detection of the passenger present in the first area and/or the object present in the second area.

4. The method according to claim 1, further comprising causing, by the controller, the opening and closing operation of the door to stop again, upon detecting, during the opening and closing operation of the door, an object present in the second area.

5. The method according to claim 1, wherein the first area contains the second area.

6. The method according to claim 1, wherein
the in-vehicle apparatus further comprises a projector configured to project an image onto a floor of the vehicle, and
the method further comprises projecting, by the controller via the projector onto the floor, an image indicating the first area and/or the second area.

7. The method according to claim 1, further comprising:
further setting, by the controller, in the video, a third area whose size varies according to a degree of opening of the door during the opening and closing operation; and
causing, by the controller, the opening and closing operation of the door to stop again, upon detecting, in the video using the image analysis technique, an object present in the third area.

8. The method according to claim 7, wherein the third area becomes smaller in size as the degree of opening of the door decreases.

9. An in-vehicle apparatus comprising:
an imager configured to image an interior of a vehicle; and
a controller configured to:
set, in video captured by the imager, a first area and a second area in front of a door in the interior of the vehicle;
extract one or more passengers and one or more objects from the video using an image analysis technique; and
cause an opening and closing operation of the door to stop, upon detecting, in the video, a passenger present in the first area and/or an object present in the second area.

10. The in-vehicle apparatus according to claim 9, wherein the second area is smaller in size than the first area.

11. The in-vehicle apparatus according to claim 9, further comprising a communication interface configured to communicate with a terminal apparatus of a user who monitors the vehicle,
wherein the controller is configured to transmit, to the terminal apparatus via the communication interface, detection information indicating detection of the passenger present in the first area and/or the object present in the second area.

12. The in-vehicle apparatus according to claim 9, wherein the controller is configured to cause the opening and closing operation of the door to stop again, upon detecting, during the opening and closing operation of the door, an object present in the second area.

13. The in-vehicle apparatus according to claim 9, wherein the first area contains the second area.

14. The in-vehicle apparatus according to claim 9, further comprising a projector configured to project an image onto a floor of the vehicle,
wherein the controller is configured to project, via the projector onto the floor, an image indicating the first area and/or the second area.

15. The in-vehicle apparatus according to claim 9, wherein the controller is configured to:
further set, in the video, a third area whose size varies according to a degree of opening of the door during the opening and closing operation; and
cause the opening and closing operation of the door to stop again, upon detecting, in the video using the image analysis technique, an object present in the third area.

16. The in-vehicle apparatus according to claim 15, wherein the third area becomes smaller in size as the degree of opening of the door decreases.

17. A non-transitory computer readable medium storing a program configured to cause a computer, as an in-vehicle apparatus comprising an imager configured to image an interior of a vehicle, and a controller, to execute operations, the operations comprising:
setting, in video captured by the imager, a first area and a second area in front of a door in the interior of the vehicle;
extracting one or more passengers and one or more objects from the video using an image analysis technique; and
causing an opening and closing operation of the door to stop, upon detecting, in the video, a passenger present in the first area and/or an object present in the second area.

18. The non-transitory computer readable medium according to claim 17, wherein the second area is smaller in size than the first area.

19. The non-transitory computer readable medium according to claim 17, wherein
the in-vehicle apparatus further comprises a communication interface configured to communicate with a terminal apparatus of a user who monitors the vehicle, and
the operations further comprise transmitting, to the terminal apparatus via the communication interface, detection information indicating detection of the passenger present in the first area and/or the object present in the second area.

20. The non-transitory computer readable medium according to claim 17, wherein the operations further comprise causing the opening and closing operation of the door to stop again, upon detecting, during the opening and closing operation of the door, an object present in the second area.
